(19) United States
(12) Patent Application Publication
(10) Pub. No.: US 2017/0372628 A1
(43) Pub. Date: Dec. 28, 2017

(54) Adaptive Reading Level Assessment for Personalized Search

(71) Applicant: CHOOSITO! INC., Wynnewood, PA (US)

(72) Inventors: David Joseph Weiss, Baltimore, MD (US); Eleni Miltsakaki, Wynnewood, PA (US)

(21) Appl. No.: 15/650,173

(22) Filed: Jul. 14, 2017

Related U.S. Application Data
(63) Continuation of application No. 14/635,655, filed on Mar. 2, 2015, now abandoned.
(60) Provisional application No. 61/946,303, filed on Feb. 28, 2014.

(51) Int. Cl. G09B 5/02; G06F 17/30; G09B 7/02; G09B 17/00

(52) U.S. Cl. CPC G09B 5/02; G09B 17/00; G06F 17/30699; G09B 7/02

(57) ABSTRACT

A system and associated methods are provided for generating a representation of the reading ability and general knowledge of a user, receiving information regarding a plurality of electronic documents, generating an estimate of the reading difficulty for the user of each electronic document of the plurality of electronic documents using the generated representation of the reading ability and general knowledge of the user, and presenting results based upon the estimates of the reading difficulty. The representation of the reading ability and general knowledge of a user may then be updated based, in part, upon feedback from the user regarding the presented results.

### CROSS-REFERENCE TO RELATED APPLICATIONS

This application is a continuation application of U.S. patent application Ser. No. 14/635,655, filed Mar. 2, 2015, which claims the benefit under 35 U.S.C. §119(e) of U.S. Provisional Application No. 61/946,303, filed Feb. 28, 2014, the entire disclosures of which are incorporated herein by reference.

### BACKGROUND OF THE INVENTION

Conducting research projects on the Internet is a difficult task, particularly for young students. Simply finding Internet sites that are useful and relevant to a particular curriculum can be challenging. Search engines are helpful, but they often fail to provide students and teachers with sites that are age appropriate, are relevant to the topic, and have educational value. Furthermore, unreliable sites can often be hard to distinguish from reputable sites, especially for students. Search rankings driven by site popularity and advertising profitability do not meet the needs of students.

To deal with these issues, teachers often direct students to specific sets of books from a library. This approach, however, deprives the students of the opportunity to train themselves in conducting their own research. In other cases, students may be directed to a set of handpicked websites. These collections, however, are difficult to create and keep up to date, given the size and rapidly changing nature of the Internet.

A more advanced, and more automatable, technique for filtering material for use by students is to analyze and segment materials based upon readability. A common shortfall of readability-based methods, however, is that they fail to take into account the impact of reader characteristics and knowledge on the perceived difficulty of the text.

What is needed is an adaptive system for analysis and selection of search results based upon automatically-determined information regarding the capabilities of the user.

### SUMMARY OF THE INVENTION

A system and associated methods are provided for generating a representation of the reading ability and general knowledge of a user, receiving information regarding a plurality of electronic documents, generating an estimate of the reading difficulty for the user of each electronic document of the plurality of electronic documents using the generated representation of the reading ability and general knowledge of the user, and presenting results based upon the estimates of the reading difficulty. The representation of the reading ability and general knowledge of a user may then be updated based, in part, upon feedback from the user regarding the presented results. The system computes individualized measures of reading difficulty that continuously adapt as the user's reading level increases, and utilizes machine learning models to characterize the thematic content of websites allowing generation of multiple thematic labels per site. The system thereby allows users, such as students, to obtain more relevant and appropriate search results.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a simplified diagram of a system 10 comprising a server 100 for providing personalized search using adaptive reading level assessment;

FIG. 2 is a high-level flowchart of an exemplary process 200 for providing search using adaptive reading level assessment using the system of FIG. 1;

FIG. 3 is a flowchart of an exemplary process for performing adaptive reading level assessment on search results using the system of FIG. 1;

FIG. 4 is an exemplary diagram of software and data storage components and data flow in the system of FIG. 1;

FIG. 5 is a diagram of an exemplary user interface 500 for use with server 100 for submission to the system of FIG. 1; and

FIG. 6 is a diagram of an exemplary page of search result of the system of FIG. 1.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

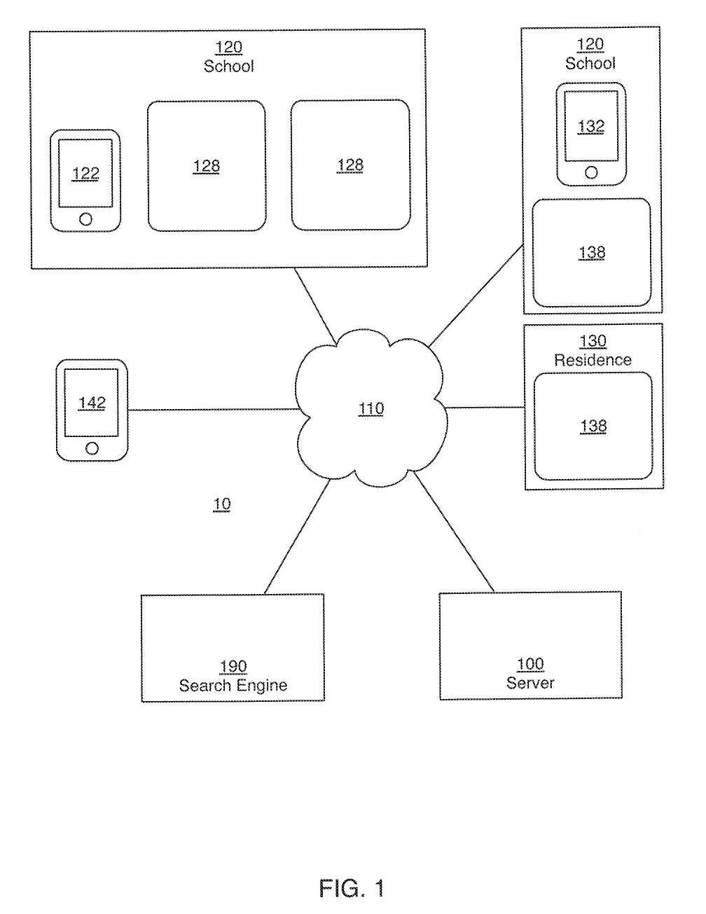

Referring to the drawings in detail, wherein like reference numerals indicate like elements throughout, FIG. 1 is a simplified diagram of a system 10 comprising a server 100 for providing personalized search using adaptive reading level assessment. Server 100 provides functions related to search, characterization of documents, characterization of users, and assessment of suitability of documents for particular users based upon those assessments. While the description refers to students and schools and uses other academically-related terms, it is to be understood that the system and methods also have applicability to non-academic settings, such as business or personal use.

In a preferred embodiment, the system is implemented as a web application and may be accessed via browsers on computers, mobile devices or any other device with access to an Internet browser. In another embodiment, the system provides an API for use by other products or services, such as digital libraries or educational software that would benefit from functions for finding reading material at specific reading levels.

While the server 100 is shown as a single entity, it is to be understood that server 100 may be implemented by any combination of computing devices, including one or more physical or virtual servers. The servers preferably implement an N-tier server infrastructure having one or more application servers, one or more web servers, and one or more database servers. The servers or server components may communicate with each other over a local area or wide area network, not shown, or, in some cases, a network 110, which may comprise portions of the Internet. The servers may be implemented using purpose-built or general purpose computing hardware, comprising processors for execution of program code for performing the processes described below, memory for storing program code and data, and interfaces for communications. Furthermore, any of the servers may utilize separate database servers for storage and retrieval of data, as well as other specialized servers or devices for other functions.

A search engine 190 provides, in some embodiments, search results based upon user queries. As with server 100, it is to be understood that search engine 190 may be implemented by any combination of computing devices, including one or more physical or virtual servers, including as a massively distributed system comprising hundreds or thousands of servers, such as the search systems provided by Google or Microsoft Bing. It is also to be understood that more than one search engine 190 may be used to obtain results for server 100.

In a preferred embodiment, user queries are submitted to server 100 and passed to search engine 190 for processing. Search results are returned to server 100 and processed before presentation to the user. In some embodiments, server 100 my implement search and indexing functions itself and not require the use of a separate search engine 190.

Mobile devices 122 and one or more computers 128 at an educational facility 120, such as a school, connect to server 100 over network 110 to, for instance, submit search queries and retrieve results. A single server 100 may provide search services to multiple educational facilities 120, and any number of mobile devices 122 and computers 128 may be utilized.

Additional mobile devices 132 or computers 128 may be utilized at residences 130 to access server 100. Mobile device 142 may also be used to access the functions of server 100. Any of mobile devices 122, 132, and 142 may communicate with the server 100 via a variety of, and combination of, networks, including wired or wireless local area networks, wide-area networks, cellular networks, and the Internet.

It is to be understood that FIG. 1 is merely an exemplary figure of one deployment of the system. Different numbers of schools 120, residences 130, mobile devices 122, 132, and 142, computers 128, and networks 110 may be utilized within the scope of the invention. Furthermore, students, school personnel, or operational personnel may also use computers 128 in other locations.

In some embodiments, users may be required to register with the system or, for instance, may be sent an email with a user name and a link to register by an instructor or administrator. The user may then be required to accept a license agreement and set a password. The users may access or login to server 100 via the web on a computer or tablet or download a mobile application for use with the server 100. In a preferred embodiment, applications are provided for the iOS and Android operating systems. The server 100 may utilize a variety of account types to allow and restrict functions for particular users.

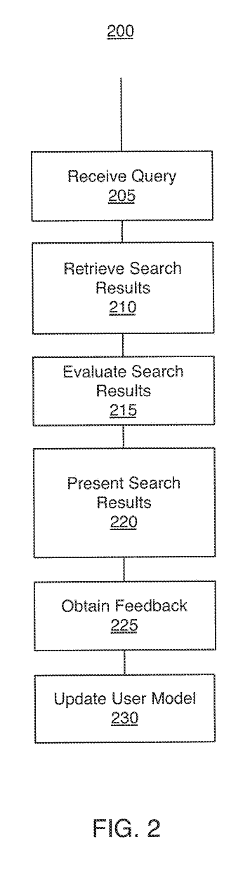

FIG. 2 is a high-level flowchart of an exemplary process 200 for providing search using adaptive reading level assessment. At 205, a search query is received from a user. At 210, search results are retrieved based upon the query from a local or remote search engine, a local or remote library of content, or some combination thereof. In a preferred embodiment, the search at 210 includes search of a community-built resource for research activities, which provides access to research activities searchable by grade and subject area and allows teachers to build individualized activity libraries in which they can edit existing activities or create and share their own.

At 215, the retrieved results are analyzed for suitability for the user submitting the query. As will be described in greater detail below, the assessment will preferably take into account information regarding the predicted capabilities of the user both generally and with respect to the content in the document. At 220, modified search results are presented to the user, preferably with those results that are most suitable to the user being presented most prominently.

At 225, user feedback is obtained regarding the presented results. In a preferred embodiment, after reviewing a result, the student may select one of three categories of feedback from: (1) “Too Easy”, (2) “OK”, or (3) “Too Hard,” which may correspond to the predictive categories of the model. At 230, the feedback is incorporated into the user model to cause the model to more accurately predict the difficulty for the student of similar documents during future evaluation of documents, for instance, for subsequent searches.

It is to be understood that while the steps are shown in a particular order, the order of some steps may be changed. For instance, in some embodiments, a particular corpus or a wide range of Internet sites may be retrieved, indexed, and evaluated prior to receiving a query from a user. Evaluation of document themes and global, or generic, readability may be performed ahead-of-time, with the personalized assessment being performed after the return of particular results in response to the user's query.

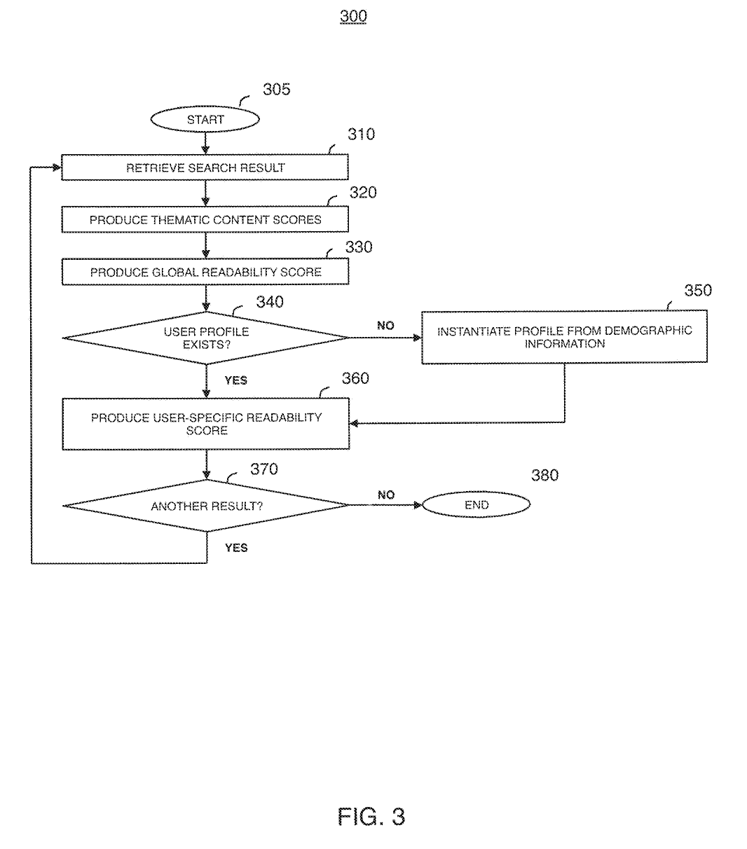

FIG. 3 is a flowchart of an exemplary process for performing adaptive reading level assessment on search results. The process 300 of FIG. 3, for instance, may be performed at 215 above.

The exemplary process begins at 305, at which point it is assumed a search query has been received from a user and corresponding search results have been retrieved for analysis. In one embodiment, a results page from a third-party search engine is obtained comprising links to search results.

At 310, a search result from a set of search results is retrieved. In a preferred embodiment, the search result is a web page accessed via a link from a list of results from a search engine. The search result may be, for instance, a web page, a PDF document, a word processing document, a presentation, or any other textual or audio/video content, or combination thereof.

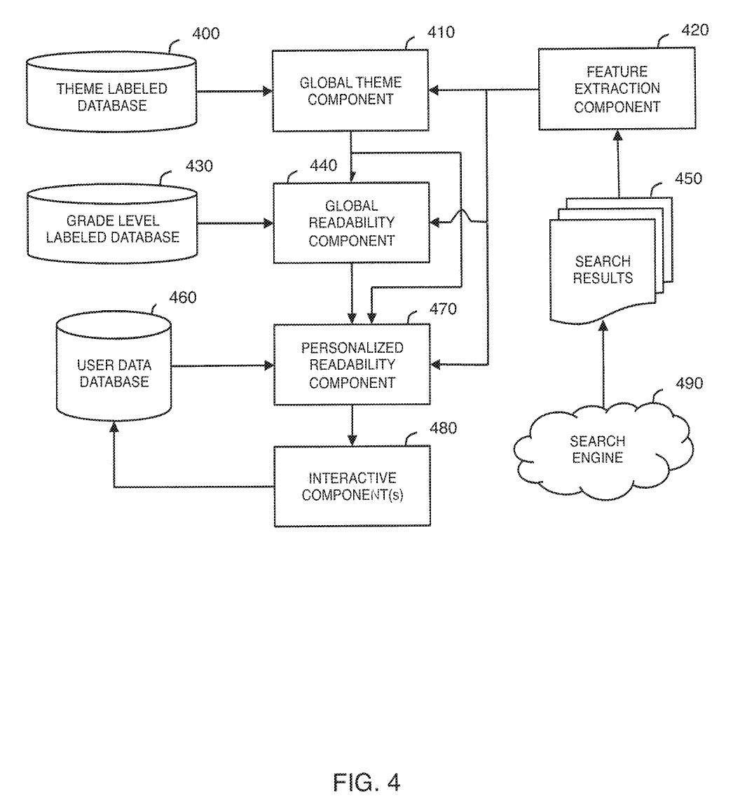

At 320, the system produces thematic content scores for the document retrieved at 310. This process may comprise extracting representative terms from the web document. At 330, a global, or generic, readability score is produced for the document. Theme analysis and global readability assessment are described further below with respect to FIG. 4.

At 340, a determination is made as to whether a profile exists for the current user. If a determination is made that no user profile exists, a new profile is created at 350. In a preferred embodiment, the new user profile is created using demographic information taken from a user database. If, at 340, a determination is made that a user profile does exist, the profile is used.

At 360, the thematic content scores and readability analysis are evaluated using the specific user data in the user profile to produce a user-specific readability score for the particular result. In a preferred embodiment, the system provides a personalized recommendation of a web site's readability that is: (1) geared for a particular student, (2) efficiently scalable to many students utilizing the system, and (3) useful even with very little data per student. In order to achieve these goals, a preferred embodiment of the present invention uses a two-tier approach to generating readability recommendations for students, with a separate global model and user-specific model functioning together.

FIG. 4 is an exemplary diagram of software and data storage components and data flow in the system 100. It is to be understood that the functions described may be separated, combined, and arranged in other ways within the scope of the invention, and that the described segmentation is merely one example.

Theme-labeled database 400 stores information regarding document themes. Global theme analysis component 410 determines likely thematic categories to which documents belong based in part on information from theme-labeled database 400. In a preferred embodiment, the global theme analysis component 410 uses a machine-learning model that is learned from data. In a preferred embodiment, themes comprise: Arts, Language & Literature, Humanities, Philosophy & Religion, Social Studies, Math, Science, Sports & Health, Business & Career, and Technology.

In a preferred embodiment, the system generally treats evaluation of thematic content as a text classification task, i.e., the task of dividing a set of documents into two or more classes and making a decision about which class or classes to which a previously unseen document belongs. A preferred text classification system can be separated into two parts: a) an informational retrieval phase, when numerical data are extracted from the text, and b) a main classification phase, when an algorithm processes these data to make a decision about the category to which a document belongs.

Thematic classifiers face multiple issues. First, web text data often fall into more than one thematic category. For example, biographies of famous mathematicians and scientists may be classified both as “social studies” and “math & science.” Forcing the system to output one label may produce erroneous or incomplete results. Second, a thematic classifier may not be able to adequately characterize the content of many web pages. Examples include pages with tables of contents, multi-theme sites such as newspapers, and pages with only images or videos etc. Third, increasingly complex page structure can make text extraction difficult.

In a preferred embodiment, these problems are addressed by the system using a variety of techniques. To address content that falls into multiple thematic categories, the system may train a Maximum Entropy classifier (McCallum 2000) using stemmed words. For each category, the system will first learn to make a binary classification (i.e., the content is, or is not, in the category). After training, the system will compare unseen text with the theme models and compute similarity. After a threshold is met, multiple thematic labels can apply. In other embodiments, the system may use and train classifiers for hierarchically connected themes (e.g., social studies, biographies, history, geography, etc.).

To address pages that are difficult to characterize, the system may analyze features extracted from the structure of the HTML page, sitemaps, images, etc., to either exclude the pages from classification or to identify other features to determine a theme.

To address text extraction issues, the system may use techniques such as Crunch (Gupta et al. 2005), Body Text Extraction (Finn et al. 2001), Document Slope Curve (Pinto et al 2002), and Link Quota Filter (Mantratzis et al. 2005), alone or in combination, and in some cases, with adjustments specific to the task.

Other heuristics may be used to improve classification. For instance, to reduce the amount of irrelevant material passed to the classifiers, only sentences contained within a single page element, beginning with a capitalized letter and ending with a period, may be considered “well formed” sentences and used to compute word features.

Feature extraction component 420 performs analysis on features of search results 450 returned by search engine 490, such as at 210 above. Feature extraction preferably comprises extraction of numerical data from the data, such as word distribution. Feature reduction reduces the computational complexity induced by processing an exploded dimensionality of feature vectors. Feature reduction can be achieved with stop words, statistical filtering and using natural language processing techniques, such as stemming, use of direct quotes, length of sentences, proportions of different parts of speech, etc. Results from feature extraction component 420 may be used by global theme component 410, global readability component 440, and personalized readability component 470.

Grade-level-labeled database 430 stores information regarding grade-level correlation with readability.

Global readability component 440 predicts an overall reading level for a search result or document, based in part on information from feature extraction component 420 and grade-level-labeled database 430. In a preferred embodiment, the global readability component 440 uses a machine-learning model that is learned from data. The global readability component 440 may be trained using various methods (e.g., Support Vector Machines) to predict the category from features computed on the text content of each document.

In a preferred embodiment, the global, or generic, readability model is defined to categorize documents into one of four reading levels, according to U.S. school grade numbers: R1 (Grades 1-3), R2 (Grades 4-6), R3 (Grades 7-9), and R4 (Grades 10-12). Other implementations of the system might involve discretizing reading level at a finer level than R1-R4, or predicting thematic content at the level of individual sub-topics (at the finest level, associating individual words). In a preferred embodiment, any biases in the training set are accounted for when training the readability classifier. For instance, vastly more webpages may be crawled in the R2 and R3 categories than the RI and R4 categories. A sub-sampled dataset may be therefore be extracted when learning and evaluating the readability classifier, wherein each category is equally likely, to reduce the bias.

Off-line training, in some cases using human evaluators of theme and reading level, may be used to train the models. The result of the off-line training procedure is a set of one or more classifiers that can provide the system with probabilistic predictions for the thematic content and overall reading level of any given document. The learning procedure may require estimating hundreds of thousands of parameters, and take minutes to learn each classifier. Therefore, such classifiers may not be optimal for learning individualized models for each student.

Several possible readability and theme classification models may be used, such as a language-based model (“Language model”) or a readability formula-based approach (“Readability Formula”). In a preferred language model, the system may learn a linear classifier with one feature per word in a vocabulary, where the feature value is the frequency of the word in a given document. A preferred readability metric is (# words per sentence)/(# long words)/(total # of words), where a long word is defined as seven letters or more. The raw score computed by the formula can then be compared to brackets to compute a R1-R4 level. Finally, the system may compute binary indicator features for each bracket and use those in a linear model, yielding a learned version of the readability formula (“Readability Features”) or combine them with the language model (“Language+Readability”).

Results from global readability component 440 are passed to the personalized readability component 470 along with the thematic categories. In a preferred embodiment, the personalized readability component 470 implements a model that takes into account reader characteristics and adapts by keeping track of the user's online reading.

Thus, unlike the global classifiers, a personalized model, implemented by personalized readability component 470, is designed to compute a relevance score for a particular student, based on a belief about that particular's student's reading abilities and knowledge base. In preferred embodiments, the model, or user data for use in the model, must be compact, for efficient storage, and easily updated in milliseconds.

A goal of the personalized model is to predict which of the categories a given document will fall into for a given student. In a preferred embodiment, a document may be labeled with one of three categories of predicted feedback from the student: (1) “Too Easy”, (2) “OK”, or (3) “Too Hard.”

In a preferred embodiment, the system uses the following parametric per-student Bayesian model:

P(response|document)=ΣₗₑᵥₑₗP(response|level)P(level|document)

This equation states that the probability of a response by the student is equal to the weighted sum of response probabilities for that student given a particular reading level, multiplied by the probability that the document falls into that reading level category (R1-R4). Since the reading level of the document is predicted by the global classifier, the only parameters are the probabilities P(response|level), which are stored

for each student for every response (1-3) and reading level (R1-R4) combination, in a preferred embodiment. According to Bayesian methodology, these parameters are initialized using a prior based on the grade level of the student, and can be updated efficiently whenever a new data point consisting of a (document, response) pair is obtained by the system.

In a preferred embodiment, the model uses student feedback to build a profile of the student's overall comfort with documents of various reading level. In other embodiments, the system will model the student's knowledge with thematic content. In this case, the parameters stored are P(response|level, theme) and the summation operates over both reading level and thematic labels:

P(response|document)=Σ_{level,theme}P(response|level,theme)P(theme|document)P(level|document)

Some embodiments may use a more elaborate linear model (e.g. Support Vector Machine or Logistic Regression) that uses arbitrary features computed on the content of the document to make a personalized prediction for each user. A difficulty in training such a model is a lack of many training examples for each student in the database; therefore a global model could be learned (possibly at the grade level) and then adapted using a state-of-the-art on-line learning update rule (e.g. MIRA or Perceptron).

In a preferred embodiment, user familiarity with the topic is considered in the assessment of personal readability. To take this characteristic into account, the system may first build vocabulary frequency indices for the range of subjects commonly encountered in education (e.g., history, science, math, sports, environment, etc.), and then adapt the evaluation of predicted difficulty with reference to these topic specific frequencies. A preferred approach differs from the Lexile framework (Smith et al. 1989, Stenner et al. 2006), which also uses vocabulary differences, in that the preferred approach builds vocabulary profiles per thematic area, not overall frequency indices computed over a corpus.

Adaptive reading evaluation is preferably handled as a feature in the readability model that, for every reader, will take into account the probability of percentage of unknown words and linguistic structures as a function of the probability of having encountered these words and structures in the readings completed over time.

In a preferred embodiment, the system will compute vocabulary distribution frequencies, as well as degree of syntactic complexity from leveled readers, to use them as correlates of age. Similarly, the system may compute vocabulary frequencies for special education students.

The model may be continuously informed by integrating linguistic analysis of web sites or other resources accessed using the system. In some embodiments, comprehension tests may be used for some sites before they are taken into account in the adaptive model.

For ELL learners, an important characteristic is the native language of the learner. The system may, for instance, use models for Spanish speakers taking into account that cognates (words sounding similar in the two languages) have a facilitating effect.

Other readability factors specific to the web may also be modeled, including layout, visual support, density of information, etc. The system may follow a hybrid approach to building readability measures, combining text-based metrics (length

of words, complexity of sentence structure, vocabulary frequencies) with joint probability language models to predict difficulty for specific user profiles. Data may be collected from a variety of resources, including leveled readers, ELL textbooks, and reading tests from students.

In a preferred embodiment, the global readability model has many parameters and is expensive to store and update, but the personalized model has few parameters and can be efficiently stored and updated for every user of the present invention. Furthermore, while the global model can be pre-computed off-line using large amounts of data, the present invention updates the personalized models “on-the-fly” assuming the global model is pre-trained and fixed.

Interactive component 480 displays results to the user, such as at 230 above. Feedback from the user regarding the presented results may then be used to update the user database 460 in real-time. Once the student is shown the search results, he or she can provide feedback by indicating which of the three feedback categories a given document falls into. This feedback is then used to update the personalized models. The labeled document is sent back to the personalized model with the student's feedback, so the model can be updated in real-time, and so the student's subsequent search query responses will be more relevant.

In a preferred embodiment, the student may select one of three categories

of feedback from: (1) “Too Easy”, (2) “OK”, or (3) “Too Hard,” which correspond to the predictive categories of the model. This feedback, when incorporated and applied via the Bayesian model, may cause the model to more accurately predict the difficulty for the student of similar documents. For instance, a student indication that a document predicted to be “OK” was “Too Easy,” may increase the likelihood that similar documents are later classified as “Too Easy.”

In some embodiments, relative student feedback may be incorporate directly into the learning procedure of the global readability classifier. This can be done through introducing ranking constraints into the optimization problem for learning the global readability classifier. The optimization problem may be solved via LIBLINEAR for SVM models or via a stochastic gradient descent solver that incorporates the ranking constraints for logistic regression.

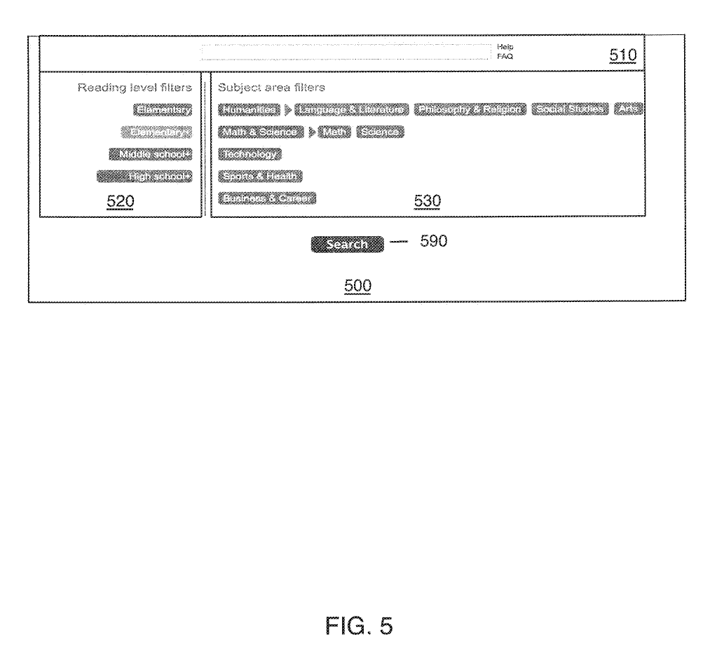

FIG. 5 is a diagram of an exemplary user interface 500 for use with server 100. It is to be understood that some of the displayed features may be optional, that the specific filters may change, and that other user interface elements may be present within the scope of the invention.

A search entry field 510 is provided for entry of search query terms. User interface buttons for reading level filters 520 are provided to allow filtering of results for a particular grade or skill level. Subject area filters 530 are provided to filter results to those determined by the server 100 to be related to a particular subject area. A search button 590 is provided to allow submission of the search query once terms have been entered in search entry field 510 and filters 520 and 530 have been selected. Information regarding the query may be transmitted from a computing device 122, 132, 142, 128, or 138 to server 100 over network 110. The query information may be received at server 100 at 205 above. It is to be understood that the layout 500 shown in FIG. 5 is arbitrary and may be modified within the scope of the invention.

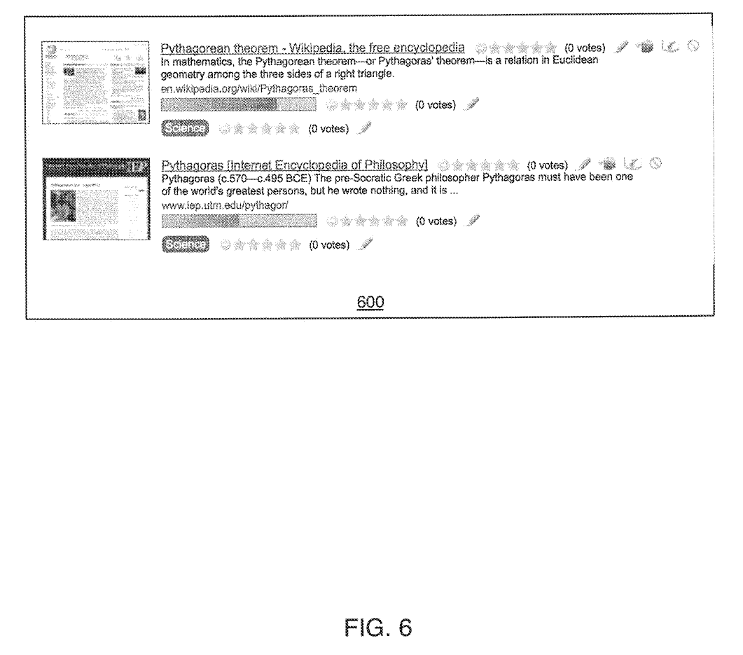

FIG. 6 is a diagram of an exemplary page of search results for presentation to the user, for instance, at 230 above. In a preferred embodiment, search results 600 are presented in decreasing order of suitability to the user. Features such as the extent of fill of a horizontal bar or other graphical element, or a textual indication, may be used to indicate the suitability of each presented result. In a preferred embodiment, the pages of search results are presented as an HTML page for viewing in a web browser. In a preferred embodiment, the results page will also comprise user interface elements to allow the user to provide feedback regarding the suitability or quality of the returned results. This feedback may be used by server 100 in further training of the model or in promotion or demotion of certain results during future searches.

Performance of the system may be evaluated, for instance, using tests involving students and teachers. The accuracy of the performance of readability filter may be evaluated with measures such as: a) ten-fold cross validation (using labeled data), b) reading comprehension questions (answered by students), and c) direct student feedback using a five-level Likert scale (too easy-too difficult). The accuracy the theme classifier may be evaluated with a) precision and recall measurements on labeled data and b) direct teacher feedback using a five-level Likert scale (way off-correct).

The system may also track or adapt based upon analysis of which keywords are used by users, how many keywords are used, the number of sites that are visited, the number of sites that are visited that are off-topic, the amount of time spent on each site, and the criteria used to evaluate sites.

Users may be queried as to whether returned sites are comprehensible and useful. The amount of time users spend on returned sites and the depth of traversal of links within returned sites may be determined. The system may also track the quantity or complexity of notes or quantity of resources recorded by users in association with returned sites. Furthermore, the quality of a resulting project may be assessed.

In a preferred embodiment, the degree of comprehensibility and usefulness are evaluated directly by the students using the star ratings that appear next to every link. Visited sites, followed links, time spent on a site (with possibility of error), notes, resources are preferably recorded on the server anonymously.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A computer-implemented method for computing a personalized estimate of reading difficulty for an electronic document, comprising:
generating a representation of the reading ability and general knowledge of a user;
receiving first information regarding a plurality of electronic documents;
generating an estimate of the reading difficulty for the user of each electronic document of the plurality of electronic documents using the generated representation of the reading ability and general knowledge of the user; and
presenting second information regarding the plurality of electronic documents based upon the estimates of the reading difficulty for each of the plurality of electronic documents generated using the representation of the reading ability and general knowledge of the user.

2. The method of claim 1 further comprising:
receiving a search query from the user; and
initiating a search based upon information from the received search query;
wherein the information regarding a plurality of electronic documents is received in response to the search query.

3. The method of claim 1 further comprising:
updating the representation of the reading ability and general knowledge of the user based at least in part upon information provided by the user regarding the presented second information regarding the plurality of electronic documents.

4. The method of claim 1 wherein the first information regarding the plurality of electronic documents comprises links to each of the plurality of electronic documents.

5. The method of claim 1 wherein the second information regarding the plurality of electronic documents comprises links to at least one of the plurality of electronic documents.

6. The method of claim 1 wherein generating the representation of the reading ability and general knowledge of a user comprises:
presenting a plurality of electronic documents to the user via a user interface device;
producing a generic semantic and reading level analysis for each of the presented documents;
obtaining an informational metric by measuring the user's implicit and explicit behavior in response to each of the presented documents; and
configuring a computational model of user response based on the user's behavior and the semantic and reading level content of the presented documents.

7. The method of claim 1 wherein generating the estimate of the reading difficulty for the user of each electronic document using the generated representation of the reading ability and general knowledge of the user comprises:
producing a generic semantic and reading level analysis of each document; and
producing a user-specific reading difficulty score by applying a computational model of the reading ability and general knowledge of the given user, given the generic semantic and reading level analysis of the document.

8. The method of claim 7 wherein producing a generic reading level analysis comprises:
producing estimates of the probability that the document is associated with each reading level category.

9. The method of claim 7 wherein producing a generic reading level analysis comprises:
determining features including one or more of: syntactic parses, semantic word associations, word frequencies, analysis of embedded image and video content, properties of hyperlink structure such as the pattern or frequency of hyperlinks.

10. The method of claim 7 wherein producing a generic reading level analysis comprises:
receiving an indication of a generic reading level to be associated with the document from a human annotator.

11. The method of claim 7 wherein producing a generic reading level analysis comprises:
receiving an indication of a generic reading level to be associated with the document from an automatic annotation system.

12. The method of claim 11 wherein the automatic annotation system is trained using a plurality of annotated documents using machine learning software.

13. The method of claim 1 wherein the presented second information are the results of a search query.

14. The method of claim 1 wherein presenting second information regarding the plurality of electronic documents based upon the estimates of the reading difficulty comprises:
filtering or ordering information regarding the electronic documents according to the personalized estimate of reading difficulty.

15. The method of claim 1 wherein generating a representation of the reading ability and general knowledge of a user comprises:
responsive to a determination that informational metrics have not yet been obtained for the given user, initializing the representation from prior estimates using user-specific demographic information.

16. The method of claim 7 wherein producing a generic semantic and reading level analysis of each document comprises:
producing one or more thematic labels for each document.

17. The method of claim 7 wherein producing a generic semantic and reading level analysis of each document comprises:
producing a categorical label indicating the grade level of each document

18. The method of claim 16 wherein producing a generic semantic and reading level analysis of each document comprises:
producing an estimate of the probability that each document contains content for one or more thematic labels.

19. The method of claim 1 wherein generating an estimate of the reading difficulty for the user of each electronic document comprises:
following Bayesian principles to estimate the probability of user response given specific conditions on the reading level and semantic content of the document.

20. The method of claim 6 wherein the informational metric is an explicit response by the user denoting the perceived reading difficulty of a given document.
